(19) United States
(12) Patent Application Publication
(10) Pub. No.: US 2007/0018776 A1
(43) Pub. Date: Jan. 25, 2007

(54) Resisting paste, resistor, and electronic parts

(75) Inventors: Hirobumi Tanaka, Chuo-ku, Tokyo (JP); Katsuhiko Igarashi, Chuo-ku (JP)

Correspondence Address: OLIFF & BERRIDGE, PLC, P.O. BOX 19928, ALEXANDRIA, VA, 22320, US

(73) Assignee: TDK Corporation, Tokyo (JP)

(21) Appl. No.: 10/558,292

(22) PCT Filed: Jun. 18, 2003
(86) PCT No.: PCT/JP03/07724

§ 371 Date: Nov. 28, 2005

(30) Foreign Application Priority Data
May 28, 2003 (JP) 2003-150489

(51) Int. Cl. H01C 7/13

(52) U.S. Cl. 338/22 R

(57) ABSTRACT

A resistor paste comprising glass material substantially free of lead, conductive material substantially free of lead, organic vehicle, and NiO and/or perovskite type crystal structured oxide. Oxides having perovskite type crystal structure can be CaTiO₃, SrTiO₃, BaTiO₃, NiTiO₃, MnTiO₃, CoTiO₃, FeTiO₃, CuTiO₃, MgTiO₃ or so. A content of glass material is 60 vol % or more and less than 91 vol %, or 63 to 88 vol % or less, and a content of conductive material is 8 vol % or more and 32 vol % or less, and a content of said NiO is more than 0 vol % and 12 vol % or less.

### BACKGROUND OF THE INVENTION

1. Field of the Invention

The present invention relates to a resistor paste, a resistor, and an electronic device.

2. Description of the Related Art

A resistor paste is generally mainly comprised of a glass material, a conductive material, and an organic vehicle (binder and solvent). The glass composition is included for adjusting the resistance value and having adhesion. The resistor paste is printed on a substrate, then fired to form a thick-film (10 to 15 μm or so) resistor.

Most of conventional resistor paste usually contains lead oxide-based glass as the glass material and ruthenium oxide or a compound of ruthenium oxide and lead as a conductive material and therefore is a leaded paste.

However, the leaded resistor paste is not desirable for an environmental pollution. Therefore, various proposals have been made for a lead free thick-film resistor paste, e.g. Japanese Patent Publication (A) No. H08-253342.

Normally, a thick-film resistor paste with a high resistance, i.e. 100 kΩ/□ or more generally shows temperature coefficient of resistance (TCR) of negative value. Accordingly, an additive such as CuO is added as TCR adjustment in order to make TCR close to zero. Various proposals are made for TCR adjustment, e.g. Japanese Patent Publication (A) No. S61-67901.

However, said method is introduced for glasses comprising lead, therefore, when the method, which is to add additives such as CuO, is introduced for resistor pastes comprising lead free conductive material and lead free glass material, it was difficult to adjust its characteristic with said conventional method. Deterioration in short time overload (STOL) characteristics occurred when TCR was adjusted.

### DISCLOSURE OF THE INVENTION

An object of the invention is to provide a lead free resistor paste suitable for obtaining a resistance with a small value of both temperature coefficient of resistance (TCR) and short time overload (STOL) characteristics. Further object of the present invention is to provide a resistor paste enabling a high resistance value and small values of both temperature coefficient of resistance (TCR) and short time overload (STOL) characteristics, and an electric device having the resistor paste, such as circuit board.

In order to achieve the above-mentioned object, a resistor paste according to the first object of the present invention comprises glass material substantially free of lead, conductive material substantially free of lead, organic vehicle and NiO as an additive.

Note that in the present invention, “substantially free of lead” means lead as impurity of 0.05 vol % or less may be included in the glass material or conductive material.

A resistor according to the first object of the present invention comprises glass material substantially free of lead, conductive material substantially free of lead, and NiO as an additive.

An electric device according to the first object of the present invention comprises electric device having resistor and said resistor comprises glass material substantially free of lead, conductive material substantially free of lead, and NiO as an additive.

In the first object of the present invention, preferably, a content of said glass material is 60 vol(volume)% or more and less than 91 vol %, and a content of said conductive material is 8 vol % or more and 32 vol % or less.

In the first object of the invention, preferably, a content of said NiO is more than 0 vol % and 12 vol % or less, more preferably, 2 vol % or more and 12 vol % or less.

In the first object of the invention, preferably, CuO is further added for an additive and a content of said CuO is more than 0 vol % and 8 vol % or less. Here, preferably, a content of said NiO is 2 vol % or more and 12 vol % or less, and a content of said CuO is 1 vol % or more and 2 vol % or less.

A resistor paste according to the second object of the invention comprises a glass material substantially free of lead, a conductive material substantially free of lead, organic vehicle, and a perovskite type crystal structured oxide as an additive.

A resistor according to the second object of the invention comprises a glass material substantially free of lead, a conductive material substantially free of lead, and a perovskite type crystal structured oxide as an additive.

An electric device according to the second object of the present invention comprises electric device having a resistor and said resistor comprises glass material substantially free of lead, conductive material substantially free of lead, and a perovskite type crystal structured oxide as an additive.

According to the second object of the invention, an oxide having a perovskite type crystal structure (a crystal structure expressed by “ABX₃”) may be a defect perovskite or a composite perovskite other than a simple perovskite such as CaTiO₃, SrTiO₃, BaTiO₃, CaZrO₃, SrZrO₃, NiTiO₃, MnTiO₃, CoTiO₃, FeTiO₃, CuTiO₃, MgTiO₃ or so. Of all those oxides, at least one from SrTiO₃, BaTiO₃ or CoTiO₃ can be used.

According to the second object of the invention, preferably, a content of said glass material is 63 vol % or more and 88 vol % or less (preferably 84 vol % or less) and a content of said conductive material is 8 vol % or more and 30 vol % or less.

According to the second object of the invention, CuO may be included and a content of said CuO is preferably more than 0 vol % and 8 vol % or less.

According to the second object of the invention, preferably, a content of said oxide having a perovskite type crystal structure is more than 0 vol % and 13 vol % or less. More preferably, a content of said oxide having a perovskite type crystal structure is 1 vol % or more and less than 12 vol %. In this case, preferably, a content of said CuO is 1 vol % or more and less than 8 vol %.

Note that when said oxide having a perovskite type crystal structure is CaTiO₃, preferably a content of said CaTiO₃ is 2 vol % or more and less than 12 vol %, and a content of said CuO is 2 vol % or more and less than 8 vol %.

According to the second object of the invention, NiO may be further included as an additive and a content of said Ni is preferably more than 0 vol % and 12 vol % or less, more preferably, 2 vol % or more and 12 vol % or less.

The present invention described below, including the first and the second objects of the invention, preferably further include MgO as an additive and a content of said MgO is 2 vol % or more and 8 vol % or less.

Preferably, a content of said NiO is more than 0 vol % and 12 vol % or less and more preferably, 2 vol % or more and 12 vol % or less.

Preferably, ZnO is further included as an additive and a content of said ZnO is 1 vol % or more and 4 vol % or less.

Preferably, said glass material comprises

A group comprising at least one kind from CaO, SrO, BaO, and MgO,

B group comprising B₂O₃ and/or SiO₂,

C group comprising ZrO₂ and/or Al₂O₃.

Preferably, said glass material comprises D group comprising at least one kind from ZnO, MnO, CuO, CoO, Li₂O, Na₂O, K₂O, P₂O₅, TiO₂, Bi₂O₃, V₂O₅ and Fe₂O₃.

Preferably, contents of said groups are;

A group: 20 mol % or more and 40 mol % or less

B group: 55 mol % or more and 75 mol % or less

C group: more than 0 mol % and less than 10 mol %

Preferably, a content of said D group is 0 mol % or more and 5 mol % or less.

Preferably, said conductive material comprises RuO₂ or complex oxides of Ru.

Preferably, the ratio (W2/W1) between the weight (W1) of all the powders of glass material, conductive material, and additives, and the weight (W2) of the organic vehicle is preferably 0.25 to 4.

In the present invention, a resistor paste is prepared by adding particular additives such as NiO, or perovskite type crystal structured oxide such as CaTiO₃ to a lead free conductive material and a lead free glass material. Therefore, said prepared resistor is possible to realize a high resistance value of for example 100 kΩ/□ or more, preferably 1MΩ/□ or more, and suppress an absolute value of TCR of for example less than ±150 ppm/° C., preferably ±100 ppm/° C., and further STOL characteristics of for example less than ±7%, preferably less than ±5%. Namely, a resistor prepared by the resistor paste as in the present invention can maintain its superior characteristics even when surrounding temperature or impressed voltage varies which leads the resistor highly useful.

A resistor according to the present invention can be applied to an electrode part of a capacitor or a inductor other than a single layer or multiple layer circuit board.

An electric device according to the present invention is not particularly limited, but for example, a circuit board, capacitor, inductor, chip resistor, or an isolator may be mentioned.

### DESCRIPTION OF THE PREFERRED EMBODIMENT

Below, the present invention will be explained in detail based on examples of the invention.

### The First Embodiment

A resistor paste according to the first embodiment of the present invention comprises glass material substantially free of lead, conductive material substantially free of lead, organic vehicle, and NiO as an additive.

Said glass material substantially free of lead is not particularly limited but preferably comprising at least one kind from CaO, SrO, BaO, and MgO, B group comprising B₂O₃ and/or SiO₂, C group comprising ZrO₂ and/or Al₂O₃. With these glass materials of groups A to C, even without lead, the STOL characteristics tend to improve. More preferably, said glass material further comprises D group comprising at least one kind from ZnO, MnO, CuO, CoO, Li₂O, Na₂O, K₂O, P₂O₅, TiO₂, Bi₂O₃, V₂O₅, and Fe₂O₃. By including D group in said glass material, the TCR and the STOL characteristics tend to improve.

In this case, contents of said each group is;

A group: 20 mol % or more and 40 mol % or less

B group: 55 mol % or more and 75 mol % or less

C group: more than 0 mol % and less than 10 mol %

D group: 0 mol % or more and 5 mol % or less, and more preferably;

A group: 25 mol % or more and 35 mol % or less

B group: 58 mol % or more and 70 mol % or less

C group: 3 mol % or more and 6 mol % or less

D group: 2 mol % or more and 5 mol % or less.

With these contents, the STOL characteristics tend to improve.

Contents of these glass materials are preferably, 60 vol % or more and less than 91 vol % and more preferably, 70 vol % or more and 89 vol % or less. If the contents of these glass materials are too small, the resistance tends to become too low, and if too large, the resistance tends to become too high.

Conductive material substantially free of lead is not particularly limited but other than ruthenium oxide, an Ag—Pd alloy, TaN, LaB₆, WC, MoSiO₂, TaSiO₂, and metals such as Ag, Au, Pd, Pt, Cu, Ni, W, and Mo may be mentioned. These substances may be used alone or in combinations of two or more types. Among these, an oxide of ruthenium is preferable. As the oxide of ruthenium, ruthenium oxide (RuO₂, RuO₃, RuO₄) and also a ruthenium-based-pyrochlore (Bi₂Ru₂O₇₋ₓ, Tl₂Ru₂O₇, etc.) or a composite oxide of ruthenium (SrRuO₃, CaRuO₃, BaRuO₃, etc.) etc. are included. Among these, oxide of ruthenium or a composite oxide of ruthenium is preferable and RuO₂, SrRuO₃, CaRuO₃, and BaRuO₃ are more preferable. With these conductive materials, even without lead, the STOL characteristics tend to improve.

Contents of these conductive materials are preferably 8 vol % or more and 32 vol % or less, more preferably 8 vol % or more and 28 vol % or less. If the contents of these conductive materials are too small, the resistance tends to become too high and the STOL characteristics tend to deteriorate, and if too large, the resistance tends to become too low.

Organic vehicle is prepared by dissolving binder in an organic solvent. Said binder is not particularly limited but suitably selected from all kinds of general binders such as ethyl cellulose and polyvinyl butyral. Organic solvent used is not particularly limited but suitably selected from all kinds of organic solvent such as terpineol, butyl carbitol, acetone, toluene, and other organic solvents may be suitably selected.

The first embodiment of the present invention is characterized in that including NiO as an additive. Therefore, the TCR and the STOL characteristics of obtained resistor can be well balanced. The content of NiO is more than 0 vol % and 12 vol % or less, more preferably, 2 vol % or more and 12 vol % or less.

The first embodiment of the present invention is preferable to further include CuO as an additive. CuO is an adjustment of the TCR. In this case, a content of CuO is more than 0 vol % and 8 vol % or less, more preferably 1 vol % or more and 2 vol % or less. If an amount of CuO added increases, STOL characteristics tend to deteriorate.

The first embodiment of the present invention is preferable to further include MgO as an additive. MgO is an adjustment of the TCR. In this case, a content of MgO is 2 vol % or more and 8 vol % or less, more preferably 4 vol % or more and 8 vol % or less. If an amount of MgO added increases, the STOL characteristics tend to deteriorate.

The other additives used for TCR adjustments are, for instance, MnO₂, V₂O₅, TiO₂, Y₂O₃, Nb₂O₅, Cr₂O₃, Fe₂O₃, CoO, Al₂O₃, ZrO₂, SnO₂, HfO₂, WO₃, Bi₂O₃ or so.

A resistor paste may be prepared by adding organic vehicle to conductive material, glass material, and all kinds of additives, then, mixed by a three roll mill or so. Note that the ratio (W2/W1) of the total weight (W1) of all the composition powders of the glass material, the conductive material, and additives, and the weight (W2) of an organic vehicle is preferably a weight range of 0.25 to 4, and more preferably 0.5 to 2. When the ratio (W2/W1) is too low, it becomes difficult to make paste and paste viscosity tends to increase, and when too high, the paste viscosity tends to become lower than a viscosity suitable for a screen-printing.

Resistor paste as mentioned above may for example be screen-printed on a substrate, such as alumina, glass ceramics, dielectric, AIN, etc., dried, then, fired at a temperature of around 800 to 900° C. for 5 to 15 minutes to obtain resistor.

The obtained resistor comprises glass material substantially free of lead, conductive material substantially free of lead, and NiO as an additive. Thickness of the resistor film may be thin but normally 1 μm or more, preferably around 10 to 15 μm or so.

The resistor according to the present embodiment can be applied to an electrode part of a capacitor or a inductor other than a single layer or multiple layer circuit board.

### The Second Embodiment

A resistor paste according to the second embodiment of the present invention comprises glass material substantially free of lead, conductive material substantially free of lead, organic vehicle, and CaTiO₃ as an additive.

Said glass material substantially free of lead, conductive material substantially free of lead, and organic vehicle are the same as those in the first embodiment of the invention. The content of the organic vehicle as in the second embodiment of the invention is the same with that of the first embodiment of the invention. However, the contents of both glass material and conductive material as in the second embodiment differ from those of the second embodiment.

Content of this glass material according to the second embodiment of the invention is preferably, 63 vol % or more and 84 vol % or less and more preferably, 70 vol % or more and 84 vol % or less. Further, content of conductive material is preferably 8 vol % or more and 30 vol % or less and more preferably, 8 vol % or more and 26 vol % or less.

The second embodiment of the present invention is characterized in that including CaTiO₃ as an additive. With this CaTiO₃, as is the same with NiO of the first embodiment of the invention, the TCR and the STOL characteristics of obtained resistor can be well balanced. The content of CaTiO₃ is preferably more than 0 vol % and 13 vol % or less, and more preferably, 2 vol % or more and less than 12 vol %.

The second embodiment of the present invention is also preferable to further include CuO as an additive. CuO is an adjustment of the TCR as is the same with the first embodiment of the invention. In this case, preferably, a content of CuO is more than 0 vol % and 8 vol % or less, and more preferably, 2 vol % or more and less than 8 vol %.

The second embodiment of the present invention is preferable to further include ZnO as an additive. ZnO is an adjustment of the TCR. In this case, preferably, a content of ZnO is 1 vol % or more and 4 vol % or less, more preferably 2 vol % or more and 4 vol % or less. When an additive of ZnO increases, the STOL characteristics tend to deteriorate.

Further, as is the same with the first embodiment of the invention, additives other than the above-mentioned additives may further be added. Other compositions, manufacturing methods, and effects of this second embodiment of the invention are the same with those of the first embodiment of the invention.

### The Third Embodiment

A resistor paste according to the present invention comprises glass material substantially free of lead, conductive material substantially free of lead, organic vehicle, and perovskite type crystal structured oxide other than CaTiO₃ as an additive.

Said glass material substantially free of lead is the same with that of the first embodiment and is not particularly limited, but preferably comprising A group selected at least one kind from CaO, SrO, BaO, and MgO, B group comprising B₂O₃ and/or SiO₂, and C group comprising ZrO₂ and/or Al₂O₃. More preferably, said glass material further comprises D group comprising at least one kind from ZnO, MnO, CuO, CoO, Li₂O, Na₂O, K₂O, P₂O₅, TiO₂, Bi₂O₃, V₂O₅, and Fe₂O₃.

In this case, contents of said each group is;

A group: 20 mol % or more and 40 mol % or less

B group: 55 mol % or more and 75 mol % or less

C group: more than 0 mol % and less than 10 mol %

D group: 0 mol % or more and 5 mol % or less, and more preferably;

A group: 25 mol % or more and 35 mol % or less

B group: 58 mol % or more and 70 mol % or less

C group: 3 mol % or more and 6 mol % or less

D group: 2 mol % or more and 5 mol % or less.

Conductive material substantially free of lead is the same with those in the first embodiment of the invention and not particularly limited, but other than ruthenium oxide, an Ag—Pd alloy, TaN, LaB₆, WC, MoSiO₂, TaSiO₂, and metals such as Ag, Au, Pd, Pt, Cu, Ni, W, and Mo may be mentioned. These substances may be used alone or in combinations of two or more types. Among these, an oxide of ruthenium is preferable. As the oxide of ruthenium, ruthenium oxide (RuO₂, RuO₃, RuO₄) and also a ruthenium-based pyrochlore (Bi₂Ru₂O₇₋ₓ, Tl₂Ru₂O₇, etc.) or a composite oxide of ruthenium (SrRuO₃, CaRuO₃, BaRuO₃, etc.) etc. are included. Among these, oxide of ruthenium or a composite oxide of ruthenium is preferable and RuO₂, SrRuO₃, CaRuO₃, and BaRuO₃ are more preferable.

Contents of these glass materials are preferably, 63 vol % or more and 88 vol % or less and more preferably, 70 vol % or more and 84 vol % or less. And contents of these conductive materials are preferably, 8 vol % or more and 30 vol % or less and more preferably, 8 vol % or more and 26 vol % or less.

The present embodiment is characterized in that comprising perovskite type crystal structured oxide other than CaTiO₃ as an additive. With this oxide, the TCR and the STOL characteristics of obtained resistor can be well balanced. Such perovskite type crystal structured oxides are preferably selected from NiTiO₃, MnTiO₃, CoTiO₃, FeTiO₃, CuTiO₃, MgTiO₃, SrTiO₃, and BaTiO₃. Content of perovskite type crystal structured oxides other than CaTiO₃ is preferably more than 0 vol % and 13 vol % or less, more preferably, 1 vol % or more and less than 12 vol %, and the most preferably, 2 vol % or more and less than 12 vol %.

The present embodiment is preferable to further include CuO and/or NiO as an additive. CuO is a TCR adjustment. In this case, content of CuO is preferably more than 0 vol % and 8 vol % or less, and more preferably, 1 vol % or more and less than 8 vol %, the most preferably, 2 vol % or more and less than 8 vol %. If an addition amount of CuO increases, the STOL characteristics tend to deteriorate.

The present embodiment is preferable to further include ZnO as an additive. ZnO is a TCR adjustment. In this case, content of ZnO is preferably 1 vol % or more and 4 vol % or less, more preferably, 2 vol % or more and 4 vol % or less. If an addition amount of ZnO increases, the STOL characteristics tend to deteriorate.

The present embodiment is preferable to further include MgO as an additive. MgO is a TCR adjustment. In this case, content of MgO is preferably 2 vol % or more and 8 vol % or less, more preferably, 4 vol % or more and 8 vol % or less. If an addition amount of MgO increases, STOL characteristics tend to deteriorate.

Further, TCR adjustment additives other than mentioned above are, MnO₂, V₂O₅, TiO₂, Y₂O₃, Nb₂O₅, Cr₂O₃, Fe₂O₃, CoO, Al₂O₃, ZrO₂, SnO₂, HfO₂, WO₃, Bi₂O₃, etc.

Resistor paste according to the present embodiment is prepared in the same way as the first embodiment of the present invention. The obtained resistor comprises glass material substantially free of lead, conductive material substantially free of lead, and perovskite type crystal structured oxide other than CaTiO₃. Thickness of the resistor film may be thin but normally 1 μm or more, preferably around 10 to 15 μm or so.

The resistor according to the present embodiment can be applied to an electrode part of a capacitor or an inductor other than a single layer or multiple layer circuit board.

Other compositions, manufacturing methods, and effects of this embodiment of the invention are the same with those of the first embodiment of the invention.

### EXAMPLE 1

Below, the present invention is described in detail with referred to concrete examples of the above-mentioned present embodiments. However, the present invention is not limited to the examples.

Preparation of Resistor Paste

Conductive materials were prepared as below. CaCO₃ or Ca(OH)₂ powder and RuO₂ powder were weighed to give formulation CaRuO₃, which was then mixed by a ball mill and dried. Obtained powder was heated to 1400° C. at a rate of 5° C./min, maintained its temperature for 5 hours, and cooled to a room temperature at a rate of 5° C./min. Obtained CaRuO₃ compound was grinded by a ball mill to CaRuO₃ powder. Using XRD, the obtained powder was confirmed to be CaRuO₃.

Glass materials were prepared as below. CaCO₃, B₂O₃, SiO₂, ZrO₂, and various oxides were weighed to give the final formulations (9 kinds) as shown in Table 1 of the invention, those were then mixed by a ball mill and dried. Obtained powder was heated to 1300° C. at a rate of 5° C./min, maintained its temperature for 1 hour, and was dropped in water to rapidly cool and vitrify. Obtained vitrified material was grinded by a ball mill to obtain glass powder. Using XRD, the obtained powder was confirmed to be amorphous.

TABLE 1

| Glass Material | |
|---|---|
| Numbers | Compositions(mol %) |
| \textcircled{1} | CaO:B₂O₃:SiO₂:ZrO₂= 34:36:25:5 |
| \textcircled{2} | CaO:B₂O₃:SiO₂ = 35:39:26 |
| \textcircled{3} | CaO:B₂O₃:SiO₂:ZrO₂= 35:33:22:10 |
| \textcircled{4} | CaO:B₂O₃:SiO₂:ZrO₂= 40:33:22:5 |
| \textcircled{5} | CaO:B₂O₃:SiO₂:ZrO₂= 35:24:36:5 |
| \textcircled{6} | CaO:B₂O₃:SiO₂:ZrO₂= 20:45:30:5 |
| \textcircled{7} | CaO:B₂O₃:SiO₂:Al₂O₃ = 34:36:25:5 |
| \textcircled{8} | CaO:B₂O₃:SiO₂:ZrO₂:ZnO = 34:32:24:5:5 |
| \textcircled{9} | CaO:B₂O₃:SiO₂:ZrO₂:MnO = 34:32:24:5:5 |

Organic vehicle was prepared as below. Terpineol as a solvent was heated and stirred and by solving ethyl cellulose as a resin, organic vehicle was prepared.

Additives were selected as shown in table 2. Prepared conductive material powder, glass powder, and selected additive were weighed to give each formulation as shown in Table 2, and organic vehicle was added, then, mixed by a three roll mill to obtain a resistor paste. The ratio of the total weight of the conductive powder, glass powder, and additive, and the weight of the organic vehicle was adjusted to a weight ratio of a range of 1:0.25 to 1:4 to prepare each resistor paste so that the obtained resistor paste had a viscosity suitable for screen printing.

Preparation of Thick-Film Resistor

A 96% purity alumina substrate was screen printed with an Ag—Pt conductor paste to a predetermined shape and then dried. Ag in the Ag—Pt conductor paste was 95 wt %, and Pt was 5 wt %. This alumina substrate was placed in a belt furnace and fired by a one-hour pattern from carrying to carrying out. The firing temperature at this time was 850° C., and the holding time at this temperature was 10 minutes. The alumina substrate formed with the conductor in this way was coated with the previously prepared resistor paste by screen printing to a predetermined shape (1 mm×1 mm) of a pattern. After this, the resistor paste was fired under the same conditions as the firing of the conductor to obtain the resistor. The thickness of the resistor film was 12 μm.

Evaluation of Thick-Film Resistor Characteristics (TCR and STOL)

TCR and STOL characteristics of the obtained thick-film resistor were evaluated. TCR was evaluated by confirming the ratio of change in resistance value when changing the temperature from room temperature of 25° C. to −55° C. (the low temperature) and 125° C. (the high temperature). Concretely, if designating the resistance values at 25° C., −55° C., and 125° C. as R25, R-55, and R125 (Ω/□), the high temperature TCR (HTCR) and the low temperature TCR (CTCR) were respectively found by HTCR=(R25−R125)/R25/100×1000000 (ppm/° C.), CTCR=(R25−(R-55))/R25/80×1000000 (ppm/° C.). Results are shown in Table 2. Note the larger of the two values is made the TCR value of table 2. Normally, TCR<±100 ppm/° C. is a bases of its characteristic.

STOL characteristics was evaluated by confirming the ratio of change in resistance value before and after applying test voltage to thick-film resistor for 5 seconds and leaving for 30 minutes. The test voltage was 2.5×rated voltage, and the rated voltage was √(R/8), where R is the resistance value (Ω/□). For resistors with resistance values with calculated test voltages over 200V, the test voltage was made 200V. The results are shown in Table 2. Normally, STOL<±5% is a bases of its characteristic.

TABLE 2

| | conductive | | glass | | | | | | |
|---|---|---|---|---|---|---|---|---|---|
| Sample | material | | material | | additives | | sheet resistance value | TCR | |
| Number | kind | vol % | kind | vol % | kind | vol % | Ω/□ | ppm/° C. | STOL % |
| *1 | CaRuO₃ | 15 | \textcircled{1} | 85 | — | — | 177600 | ±1200 | −0.8 |
| *2 | CaRuO₃ | 12 | \textcircled{1} | 87 | CuO | 1 | 132100 | ±95 | −13.7 |
| 3 | CaRuO₃ | 28 | \textcircled{1} | 60 | NiO | 12 | 110100 | ±90 | −0.8 |
| 4 | CaRuO₃ | 26 | \textcircled{1} | 70 | NiO | 4 | 146700 | ±100 | −1.5 |
| 5 | CaRuO₃ | 28 | \textcircled{2} | 68 | NiO | 4 | 109600 | ±95 | −5.4 |
| 6 | CaRuO₃ | 27 | \textcircled{3} | 69 | NiO | 4 | 115500 | ±80 | −6.0 |
| 7 | CaRuO₃ | 26 | \textcircled{4} | 70 | NiO | 4 | 103300 | ±100 | −1.8 |
| 8 | CaRuO₃ | 24 | \textcircled{5} | 72 | NiO | 4 | 150400 | ±95 | −2.1 |
| 9 | CaRuO₃ | 26 | \textcircled{6} | 70 | NiO | 4 | 146200 | ±100 | −2.3 |
| 10 | CaRuO₃ | 20 | \textcircled{7} | 74 | NiO | 6 | 153100 | ±85 | −1.9 |
| 11 | CaRuO₃ | 22 | \textcircled{8} | 72 | NiO | 6 | 128800 | ±75 | −1.6 |
| 12 | CaRuO₃ | 20 | \textcircled{9} | 77 | NiO | 3 | 134100 | ±90 | −3.3 |
| 13 | CaRuO₃ | 14 | \textcircled{1} | 79 | NiO | 6 | 123100 | ±80 | −1.2 |
| | | | | | CuO | 1 | | | |
| 14 | CaRuO₃ | 8 | \textcircled{1} | 89 | NiO | 2 | 130100 | ±50 | −1.5 |
| | | | | | CuO | 2 | | | |
| 15 | CaRuO₃ | 14 | \textcircled{1} | 75 | NiO | 6 | 114000 | ±70 | −0.9 |
| | | | | | CuO | 1 | | | |
| | | | | | MgO | 4 | | | |
| *16 | CaRuO₃ | 12 | \textcircled{1} | 88 | — | — | 1067000 | ±1200 | −0.9 |
| *17 | CaRuO₃ | 8 | \textcircled{1} | 91 | CuO | 1 | 1537000 | ±160 | −27.7 |
| 18 | CaRuO₃ | 14 | \textcircled{1} | 69 | NiO | 12 | 1072000 | ±100 | −2.5 |
| | | | | | CuO | 1 | | | |
| | | | | | MgO | 4 | | | |
| 19 | CaRuO₃ | 12 | \textcircled{1} | 70 | NiO | 8 | 1481000 | ±100 | −4.3 |
| | | | | | CuO | 2 | | | |
| | | | | | MgO | 8 | | | |
| 20 | CaRuO₃ | 15 | \textcircled{1} | 72 | NiO | 13 | 1672000 | ±160 | −5.5 |
| | | | | | CuO | 1 | | | |
| | | | | | MgO | 4 | | | |
| 21 | CaRuO₃ | 22 | \textcircled{1} | 70 | NiO | 3 | 10060 | ±80 | 0.0 |
| | | | | | CuO | 1 | | | |
| | | | | | MgO | 2 | | | |
| 22 | CaRuO₃ | 15 | \textcircled{1} | 81 | CaTiO₃ | 4 | 356800 | ±100 | 0.0 |
| 23 | CaRuO₃ | 12 | \textcircled{1} | 78 | CaTiO₃ | 6 | 965300 | ±100 | −1.2 |
| | | | | | CuO | 4 | | | |
| 24 | CaRuO₃ | 15 | \textcircled{1} | 65 | CaTiO₃ | 12 | 1207000 | ±100 | −4.8 |
| | | | | | CuO | 8 | | | |
| 25 | CaRuO₃ | 8 | \textcircled{1} | 84 | CaTiO₃ | 4 | 1108000 | ±95 | −2.5 |
| | | | | | CuO | 3 | | | |
| | | | | | ZnO | 1 | | | |
| 26 | CaRuO₃ | 12 | \textcircled{1} | 82 | CaTiO₃ | 2 | 171600 | ±75 | −0.5 |
| | | | | | CuO | 2 | | | |
| | | | | | ZnO | 2 | | | |
| 27 | CaRuO₃ | 14 | \textcircled{1} | 74 | CaTiO₃ | 4 | 16020 | ±75 | 0.0 |
| | | | | | CuO | 4 | | | |
| | | | | | ZnO | 4 | | | |
| 28 | CaRuO₃ | 30 | \textcircled{1} | 63 | CaTiO₃ | 4 | 10060 | ±60 | 0.0 |
| | | | | | CuO | 3 | | | |

*are comparative examples of the invention

As shown in Table 2, the followings were found by samples 1 to 3 those having or not having the additives. Sample 1 without any additive, could suppress STOL characteristics as low as −0.8%, however, showed deterioration in TCR. Sample 2 comprising CuO as an additive, compared to sample 1, could suppress TCR as low as ±95%, however, showed deterioration in STOL characteristics as −13.7%. To the contrary, sample 3 comprising NiO as an additive, could adjust TCR within ±100%, and suppress STOL character ristics to −0.8%. Note that samples 1 and 2 are comparative examples and sample 3 is an example of the invention.

The followings could be found by samples 4 to 12 wherein glass compositions were varied. Sample 6 comprising glass including 10 mol % of ZrO₂ (C group), compared to sample 5 comprising glass not including ZrO₂, tends to deteriorate in STOL characteristics, however, it was within the tolerance level. The same tendency was found when ZrO₂ was changed to Al₂O₃ (C group) as in sample 10. As in samples 4 and 7 to 9, their characteristics were maintained within a range of glass compositions. An adjustment of glass compositions aim to adjust glass characteristics such as softening point did not effect TCR nor STOL characteristics. Note that when the same experiments were done except CaO (A group) was substituted with the same II group, i.e. MgO, SrO or BaO, the same tendencies were found. It was confirmed that when ZnO or MnO (both in D group) was further added as in sample 11 or 12, there was no effect on TCR or STOL characteristics. Samples 4 to 12 respectively show examples of the invention.

It was effective for an adjustment of TCR and STOL characteristics when the other additives were included in addition to NiO as in samples 13 to 15 and 18 to 21. Particularly, a combination of NiO and CuO was effective, and by further adding MgO, STOL characteristics can be suppressed low (Samples 15 and 18 to 21). However, sample 20 showed deterioration in TCR. It may be due to a large amount of NiO included. Resistance values of 1MΩ as in samples 16 and 17 were one digit higher than those of 100 KΩ as in samples 1 and 2. Said sample 16 not including additives showed the same tendency as in sample 1. And said sample 17 including CuO as an additive showed the same tendency as in sample 2. Note, samples 13 to 15 and 18 to 21 are examples of the invention and samples 16 and 17 are comparative examples of the same.

The followings may be obtained when an additive was changed from NiO to CaTiO₃ as in samples 22 to 28. When CaTiO₃ was added independently as in sample 22, not much effect was shown in TCR adjustment, however, remarkable effect was shown to decrease STOL characteristics. The same remarkable decrease in STOL characteristics was shown when the other additives were added in addition to CaTiO₃ as in samples 23 to 28. Particularly, a combination of CaTiO₃ and CuO was effective and when ZnO was further added as in samples 25 to 27, STOL characteristics can further be decreased. Note that each of samples 22 to 28 is an example of the invention.

With reference to samples 21, 27 and 28, by comprising NiO or CaTiO₃ as an additive, even with a resistor having a low resistor value of 10 KΩ or less, superior TCR and STOL characteristics can be obtained.

### EXAMPLE 2

A resistor paste was prepared in the same way as example 1 except conductive material powder, glass powder, and additives were weighed to give the formulations as shown below in Table 3. Further, thick-film resistors were prepared in the same way as example 1 of the invention, and the same measurements were done to said resistors. The results are shown in Table 3 of the invention.

TABLE 3

| | conductive | | glass | | | | | | |
|---|---|---|---|---|---|---|---|---|---|
| Sample | material | | material | | additives | | sheet resistance value | TCR | |
| Number | kind | vol % | kind | vol % | kind | vol % | Ω/□ | ppm/° C. | STOL % |
| *1 | CaRuO₃ | 15 | \textcircled{1} | 85 | — | — | 177600 | ±1200 | −0.8 |
| *2 | CaRuO₃ | 12 | \textcircled{1} | 87 | CuO | 1 | 132100 | ±95 | −13.7 |
| 29 | CaRuO₃ | 18 | \textcircled{1} | 78 | SrTiO₃ | 4 | 149900 | ±90 | −1.1 |
| 30 | CaRuO₃ | 18 | \textcircled{1} | 78 | BaTiO₃ | 4 | 268000 | ±100 | −2.1 |
| 31 | CaRuO₃ | 18 | \textcircled{1} | 78 | SrTiO₃ | 2 | 209000 | ±95 | −1.5 |
| | | | | | BaTiO₃ | 2 | | | |
| 32 | CaRuO₃ | 18 | \textcircled{1} | 80 | CaZrO₃ | 2 | 171500 | ±95 | −4.2 |
| 33 | CaRuO₃ | 18 | \textcircled{1} | 80 | SrZrO₃ | 2 | 135500 | ±100 | −4.5 |
| 34 | CaRuO₃ | 28 | \textcircled{2} | 68 | SrTiO₃ | 4 | 105000 | ±100 | −1.6 |
| 35 | CaRuO₃ | 27 | \textcircled{3} | 69 | SrTiO₃ | 4 | 130300 | ±100 | −4.0 |
| 36 | CaRuO₃ | 26 | \textcircled{4} | 70 | SrTiO₃ | 4 | 145000 | ±100 | −2.8 |
| 37 | CaRuO₃ | 24 | \textcircled{5} | 72 | SrTiO₃ | 4 | 162400 | ±100 | −3.1 |
| 38 | CaRuO₃ | 26 | \textcircled{6} | 70 | SrTiO₃ | 4 | 113500 | ±100 | −3.3 |
| 39 | CaRuO₃ | 20 | \textcircled{7} | 74 | SrTiO₃ | 6 | 180200 | ±85 | −2.9 |
| 40 | CaRuO₃ | 22 | \textcircled{8} | 72 | SrTiO₃ | 6 | 103400 | ±80 | −2.3 |
| 41 | CaRuO₃ | 20 | \textcircled{9} | 77 | SrTiO₃ | 3 | 120800 | ±85 | −4.0 |
| 42 | CaRuO₃ | 28 | \textcircled{2} | 68 | BaTiO₃ | 4 | 223000 | ±100 | −1.9 |
| 43 | CaRuO₃ | 27 | \textcircled{3} | 69 | BaTiO₃ | 4 | 203000 | ±100 | −4.2 |
| 44 | CaRuO₃ | 26 | \textcircled{4} | 70 | BaTiO₃ | 4 | 254400 | ±100 | −3.0 |
| 45 | CaRuO₃ | 24 | \textcircled{5} | 72 | BaTiO₃ | 4 | 261600 | ±100 | −3.5 |
| 46 | CaRuO₃ | 26 | \textcircled{6} | 70 | BaTiO₃ | 4 | 210500 | ±100 | −3.6 |
| 47 | CaRuO₃ | 20 | \textcircled{7} | 74 | BaTiO₃ | 6 | 280000 | ±95 | −3.2 |
| 48 | CaRuO₃ | 22 | \textcircled{8} | 72 | BaTiO₃ | 6 | 234100 | ±85 | −4.4 |
| 49 | CaRuO₃ | 20 | \textcircled{9} | 77 | BaTiO₃ | 3 | 287500 | ±90 | −4.9 |
| 50 | CaRuO₃ | 8 | \textcircled{1} | 88 | SrTiO₃ | 3 | 1317000 | ±100 | −2.2 |
| | | | | | CuO | 1 | | | |
| 51 | CaRuO₃ | 8 | \textcircled{1} | 71 | BaTiO₃ | 13 | 1022000 | ±95 | −2.8 |
| | | | | | CuO | 8 | | | |
| 52 | CaRuO₃ | 18 | \textcircled{1} | 63 | SrTiO₃ | 13 | 1370000 | ±100 | −1.3 |
| | | | | | CuO | 2 | | | |
| | | | | | ZnO | 4 | | | |
| 53 | CaRuO₃ | 30 | \textcircled{1} | 66 | BaTiO₃ | 1 | 15230 | ±75 | −0.7 |
| | | | | | CuO | 2 | | | |
| | | | | | ZnO | 1 | | | |
| 54 | CaRuO₃ | 16 | \textcircled{1} | 76 | SrTiO₃ | 4 | 121900 | ±80 | −2.6 |
| | | | | | CuO | 2 | | | |
| | | | | | MgO | 2 | | | |
| 55 | CaRuO₃ | 15 | \textcircled{1} | 71 | BaTiO₃ | 4 | 253700 | ±100 | −4.1 |
| | | | | | CuO | 2 | | | |
| | | | | | MgO | 8 | | | |
| 56 | CaRuO₃ | 10 | \textcircled{1} | 69 | SrTiO₃ | 1 | 120300 | ±80 | −3.3 |
| | | | | | CuO | 8 | | | |
| | | | | | NiO | 12 | | | |
| 57 | CaRuO₃ | 12 | \textcircled{1} | 80 | BaTiO₃ | 4 | 237200 | ±100 | −3.3 |
| | | | | | CuO | 3 | | | |
| | | | | | NiO | 1 | | | |
| 58 | CaRuO₃ | 15 | \textcircled{1} | 81 | NiTiO₃ | 4 | 563400 | ±95 | −2.1 |
| 59 | CaRuO₃ | 15 | \textcircled{1} | 81 | MnTiO₃ | 4 | 231100 | ±90 | −4.0 |
| 60 | CaRuO₃ | 15 | \textcircled{1} | 81 | CoTiO₃ | 4 | 197800 | ±100 | −4.1 |
| 61 | CaRuO₃ | 15 | \textcircled{1} | 81 | FeTiO₃ | 4 | 277300 | ±100 | −4.4 |
| 62 | CaRuO₃ | 15 | \textcircled{1} | 81 | CuTiO₃ | 4 | 152100 | ±85 | −3.7 |
| 63 | CaRuO₃ | 15 | \textcircled{1} | 81 | MgTiO₃ | 4 | 303000 | ±80 | −0.5 |

*are comparative examples of the invention

As shown in Table 3, the followings were found by samples 1, 2 and 29 to 33, those depending on the additives. Sample 1 without any additive, could suppress STOL characteristics as low as −0.8%, however, showed deterioration in TCR. Sample 2 comprising CuO as an additive, compared to sample 1, could suppress TCR as low as ±95%, however, showed deterioration in STOL characteristics as −13.7%. To the contrary, samples 29 to 33, comprising at least SrTiO₃ or BaTiO₃ as an additive, could adjust TCR within ±100%, and suppress STOL characteristics to −0.8%. Note samples 1 and 2 are comparative examples and samples 29 to 33 are examples of the invention.

The followings could be found by samples 34 to 49 wherein glass compositions were varied. Samples 35 and 43 comprising glass including 10 mol % of ZrO₂ (C group), compared to samples 34 and 42 comprising glass not including ZrO₂, tends to deteriorate in STOL characteristics, however, it was within the tolerance level. The same tendency was found when ZrO₂ was changed to Al₂O₃ (C group) as in samples 39 and 47. As in samples 39 to 41 and 47 to 49, their characteristics were maintained within a range of glass compositions. An adjustment of glass compositions aim to adjust glass characteristics such as softening point did not effect TCR nor STOL characteristics. Note that when the same experiments were done except CaO (A group) was substituted with the same II group, i.e. MgO, SrO or BaO, the same tendencies were found. It was confirmed that when ZnO or MnO (both in D group) was further added as in samples 40, 41, 48 and 49, there was no effect on TCR or STOL characteristics. Note samples 34 to 49 respectively show examples of the invention.

It was effective for an adjustment of TCR and STOL characteristics when the other additives were included in addition to SrTiO₃ and BaTiO₃ as in samples 50 to 57. Particularly, a combination of SrTiO₃ or BaTiO₃ and CuO was effective, and by further adding MgO and/or NiO, STOL characteristics can be suppressed low.

Further, when glass material of \textcircled{1} as in Table 1 and additives of NiTiO₃, MnTiO₃, CoTiO₃, FeTiO₃, CuTiO₃, MgTiO₃ instead of SrTiO₃ or BaTiO₃ as in samples 58 to 63 were used, the same effects were obtained when SrTiO₃ or BaTiO₃ were added. Note that samples 50 to 63 are examples of the invention.

While the invention has been described with reference to specific embodiments chosen for purpose of illustration, it should be apparent that numerous modifications could be made thereto by those skilled in the art without departing from the basic concept and scope of the invention.

1. A resistor paste comprising glass material substantially free of lead, conductive material substantially free of lead, organic vehicle, and NiO as an additive.

2. The resistor paste as set forth in said claim 1, comprising:
60 vol % or more and less than 91 vol % of glass material and 8 vol % or more and 32 vol % or less of conductive material.

3. The resistor paste as set forth in claim 1 or 2, comprising more than 0 vol % and 12 vol % or less of NiO.

4. The resistor paste as set forth in claim 3, comprising 2 vol % or more and 12 vol % or less of NiO.

5. The resistor paste as set forth in any one of the claims 1 to 4, further comprising CuO as an additive and a content of said CuO is more than 0 vol % and 8 vol % or less.

6. The resistor paste as set forth in claim 5, comprising:
2 vol % or more and 12 vol % or less of NiO and more than 1 vol % and 2 vol % or less of CuO.

7. A resistor paste comprising:
glass material substantially free of lead, conductive material substantially free of lead, organic vehicle and CaTiO3 as an additive.

8. The resistor paste as set forth in claim 7, comprising:
63 vol % or more and 84 vol % or less of the glass material and 8 vol % or more and 30 vol % or less of the conductive material.

9. The resistor paste as set forth in claim 7 or 8, further comprising CuO as an additive and a content of said CuO is more than 0 vol % and 8 vol % or less.

10. The resistor paste as set forth in claim 9, comprising 1 vol % or more and 2 vol % or less of CuO.

11. The resistor paste as set forth in any one of the claims 7 to 10, comprising more than 0 vol % and 13 vol % or less of CaTiO3.

12. The resistor paste as set forth in claim 9, comprising 2 vol % or more and less than 12 vol % of CaTiO3 and 2 vol % or more and less than 8 vol % of CuO.

13. The resistor paste as set forth in any one of the claims 7 to 12, further comprising NiO as an additive and a content of Ni is more than 0 vol % and 12 vol % or less.

14. The resistor paste as set forth in claim 13 comprising 2 vol % or more and 12 vol % or less of NiO.

15. A resistor paste comprising glass material substantially free of lead, conductive material substantially free of lead, organic vehicle, and perovskite type crystal structured oxide as an additive.

16. The resistor paste as set forth in claim 15 wherein said perovskite type crystal structured oxide is at least one kind from CaTiO3, SrTiO3, BaTiO3, NiTiO3, MnTiO3, CoTiO3, FeTiO3, CuTiO3, MgTiO3.

17. The resistor paste as set forth in claim 15 or 16 comprising:
63 vol % or more and 88 vol % or less of glass material and 8 vol % or more and 30 vol % or less of conductive material.

18. The resistor paste as set forth in any one of the claims 15 to 17 wherein a content of said perovskite type crystal structured oxide is more than 0 vol % and 13 vol % or less.

19. The resistor paste as set forth in any one of the claims 15 to 18 further comprising CuO as an additive and a content of said CuO is more than 0 vol % and 8 vol % or less.

20. The resistor paste as set forth in any one of the claims 15 to 19 further comprising NiO as an additive and a content of said NiO is more than 0 vol % and 12 vol % or less.

21. The resistor paste as set forth in any one of the claims 1 to 20, further comprising MgO as an additive and a content of said MgO is 2 vol % or more and 8 vol % or less.

22. The resistor paste as set forth in any one of the claims 1 to 21, further comprising ZnO as an additive and a content of said ZnO is 1 vol % or more and 4 vol % or less.

23. The resistor paste as set forth in claim 19, comprising:
1 vol % or more and less than 12 vol % of perovskite type crystal structured oxide, and 1 vol % or more and less than 8 vol % of CuO.

24. The resistor paste as set forth in any one of claims 1 to 23, comprising:
A group comprising at least one kind from CaO, SrO, BaO, and MgO, B group comprising B2O3 and/or SiO2, and C group comprising ZrO2 and/or Al₂O₃.

25. The resistor paste as set forth in claim 24, wherein said glass material further comprises D group selected at least one kind from ZnO, MnO, CuO, CoO, Li2O, Na2O, K2O, P2O5, TiO2, Bi2O3, V2O5 and Fe2O3.

26. The resistor paste as set forth in claim 24, wherein contents of said groups are:
A group of 20 mol % or more and 40 mol % or less, B group of 55 mol % or more and 75 mol % or less and C group of more than 0 mol % and less than 10 mol %.

27. The resistor paste as set forth in claim 25, comprising D group of 0 mol % or more and 5 mol % or less.

28. The resistor paste as set forth in any one of the claims 1 to 27, comprising the conductive material including RuO2 or complex oxides of Ru.

29. The resistor paste as set forth in any one of the claims 1 to 28, wherein the ratio (W2/W1) between the weight (W1) of all powders of glass material, conductive material, and additive and the weight (W2) of organic vehicle is 0.25 to 4.

30. A resistor comprising glass material substantially free of lead, conductive material substantially free of lead, and NiO as an additive.

31. A resistor comprising glass material substantially free of lead, conductive material substantially free of lead, and CaTiO3 as an additive.

32. A resistor comprising glass material substantially free of lead, conductive material substantially free of lead, perovskite type crystal structure oxide as an additive.

33. An electric device having a resistor paste, wherein said resistor paste comprising: glass material substantially free of lead, conductive material substantially free of lead, and NiO as an additive.

34. An electric device having a resistor paste, wherein said resistor paste comprising: glass material substantially free of lead, conductive material substantially free of lead, and CaTiO3 as an additive.

35. An electric device having a resistor paste, wherein said resistor paste comprising: glass material substantially free of lead, conductive material substantially free of lead, and perovskite type crystal structured oxide as an additive.
